(19) United States
(12) Patent Application Publication
(10) Pub. No.: US 2009/0100012 A1
(43) Pub. Date: Apr. 16, 2009

(54) SEARCH ENGINE BASED SELF-TEACHING SYSTEM

(75) Inventor: Reto Gfeller, Boswil (CH)

Correspondence Address: PEARNE & GORDON LLP, 1801 EAST 9TH STREET, SUITE 1200, CLEVELAND, OH, 44114-3108, US

(73) Assignee: SDN AG, Obfelden (CH)

(21) Appl. No.: 11/814,754

(22) PCT Filed: Jan. 27, 2006
(86) PCT No.: PCT/CH2006/000056

§ 371 Date: May 7, 2008

(30) Foreign Application Priority Data
Feb. 2, 2005 (CH) 150/05

(51) Int. Cl. G06F 7/06; G06F 17/30

(52) U.S. Cl. 707/3; 707/E17.108

(57) ABSTRACT

The invention relates to the structured addition to search engines on the internet, intranet and/or individual networks, whereby at least one entry or so-called link or address is selected from a list of information relating to at least one particular search term. Said entry is placed in a separate file or type of basket and subsequently the selected entries and links are optionally structured or ordered and returned to the original list for the particular search term as a new entry or selection and marked as a special selection.

This invention relates to a method for supplementing search engines with menus and teaching modules and perhaps a learning window as specified in the preamble of claim 1, as well as a teaching module as specified in the preamble of claim 8.

Teaching modules are supplemental entries in the results list of a search engine. When a teaching module is selected, that module causes a learning window to guide the user through the other informational details. Teaching modules are created by a specific method.

As in the case of a recipe where individual ingredients, a sequence of actions and supplemental instructions produce a meal, a teaching module, consisting of individual pieces of information, a sequence of teaching actions and supplemental instructions will produce knowledge for the user.

So-called search engines on the Internet or even on local networks, such as Yahoo, Altavista, Google, ProFusion, MSN.com, etc. are to an ever increasing extent replacing traditional dictionaries, encyclopedic reference books, textbooks and the like. These search engines are increasingly used for teaching purposes as well. Moreover, industrial enterprises, service providers and others are generating proprietary search engines tailored to the specific requirements of the individual companies.

A major drawback of all these search tools lies in the fact that entering a particular search word leads to the display of a huge volume of pieces of information, typically overwhelming the user especially when it comes to a learning process. The often voluminous list of individual data is sorted, if at all, along certain automatable criteria such as date, subject or frequency of access. As often as not, the information that would expand the user's existing knowledge base cannot be found, or he gives up on his search early on.

This inadequacy is particularly irksome when an attempt is made to use these search tools for systematic learning or self-teaching. In other words, self-teaching is next to impossible since one does not know where to begin. The student would have to know at what informational detail, or even at what part thereof, he should start and in what sequence he should proceed. Building on his current knowledge level he should be guided, step-by-step along didactic principles, from the fundamentals to the details, something that is simply not possible with the search tools available today.

It is therefore one objective of this present invention to make it possible, when entering one or several search words in these so-called search engines on the Internet or on a local area network, to structure the list of information found in a manner whereby access to and search for specific information is simplified and weighted by predefined criteria. Another objective consists in the creation of self-teaching tools, allowing these search engines to be used as a learning aid as well.

According to the invention, these objectives are achieved in particular by a method as described in claim 1.

This invention makes it possible, when entering one or several search words in the so-called search engines on the Internet or on a local area network, to supplement the results list of individual data found with a user-specific selection and/or with user-specific teaching modules. When the user selects a teaching module, a teaching module-related learning window will guide him in didactically convenient, controlled and simple fashion to the desired information on the basis of a selection of appropriate data.

In essence, it is possible for every user to catalog the individual pieces of information existing in the search engine concerned and to create teaching modules. In this context he can follow the traditional approach by accessing (establishing links to) the knowledge base existing in computer networks in the form of files and web pages, or he can refer to literature or excerpts (printed publications etc.) not available on the computer network, or he can refer to experts (people). Entries of that nature will hereinafter be identified as “bibliographic references” or “expert references”, respectively. The search engine thus becomes a knowledge transfer system.

According to the invention, the first step to be taken is to select from a results list, brought up by a so-called search engine on the Internet or on the local area network in response to a search word, one or several entries or individual terms and to place these in a separate file as a draft selection or for instance as the draft of a teaching module. After the selection has been made, the draft selection or draft teaching module contained in the separate file is opened and structured along didactic considerations, expanded and sorted. Thereafter, that selection or teaching module, constituting a new entry, is transferred back into the original results list of the search engine and tagged as a selection and/or teaching module. An indication is provided as to what knowledge can be acquired from that selection or teaching module and for whom the selection or teaching module would be useful. Now, entering the same search word again will display the selection or teaching module, preferably at the top of the original results list.

In this fashion it is possible, for instance for a person specially assigned to this activity, to create menus or teaching modules for specific search words and the particular requirements of specific user groups, eliminating for these users the difficult task of collecting and assembling from the computer network and from existing literature the detailed information needed for the learning process. The user simply clicks on the teaching module concerned, whereupon a learning window will promptly guide him in controlled, didactically correct fashion through the other data in the search engine and to the desired information.

In a highly efficient implementation of the invention, the teaching modules include references to existing literature frequently used in training courses and available to the student in printed form. The system thus expands existing literature and course documentation into a computer-assisted correspondence course.

As a further enhancement, for instance when a teaching module is created, it is possible to enter additional instructions for each learning step. By way of these instructions the author of a teaching module can add important informational details. For example, he can tell the student how to go about the particular learning step, from what perspective individual data should be acquired, where the essentials can be found in a selected link, etc. Quite often, the individual entries and links in a search engine, also used in a teaching module, are voluminous while individual items needed for learning cannot be found right away. This applies in particular to bibliographic references. The instructions for a particular step within the teaching module can point the user in targeted fashion to the individual information section of interest, which further facilitates self-teaching.

In another form of implementation, supplemental steps are added to a given selection or teaching module. These additional steps may be comments, quizzes, exercises etc.

Interactive quizzes in particular, with the answers checked for correctness in the learning window, turn a search engine thus expanded into a self-teaching system or, expressed in more general terms, into a knowledge transfer system. As a specific example, in the case of company-internal search tools it is possible to prepare for the employees, in simple fashion and mostly from already existing material, a self-teaching course in which the teaching modules are added to the search process. In a service business, for instance a bank, a group of employees can be assigned the task of setting up or editing a search engine for various search words by means of which an abundance of information can be obtained from the Internet or intranet. Available information, bundled by intranet files and folders, literature documents, and experts, can be added to the search engine and catalogued. This can be done manually or automatically.

In an additional step, several target-group-specific teaching modules, including, where appropriate, target-group-specific instructions, quizzes, tests and exercises can be generated with regard to the same individual pieces of information, turning a search engine into a knowledge transfer system.

Selection lists or menus as well as teaching modules may be modified at any time, or copied and modified, for adaptation to other target groups.

As a rule, a search engine of that type, with its teaching modules, is for company-internal use and is not available to extraneous users. But, of course, the global search engines mentioned above, such as Yahoo, ProFusion or Google, might make such teaching modules globally available to their respective users.

The following will further explain this invention with the aid of examples and with reference to the attached figures in the form of block diagrams in which:

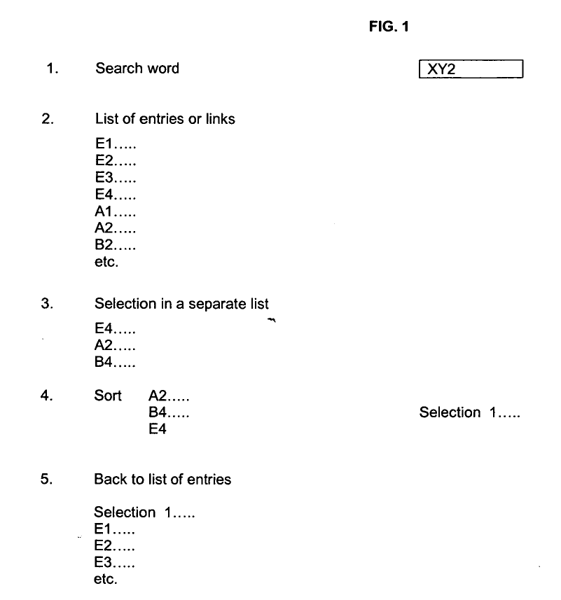

FIG. 1 is a schematic illustration of the creation of a selection, for instance a teaching module, from a results list created on a search engine;

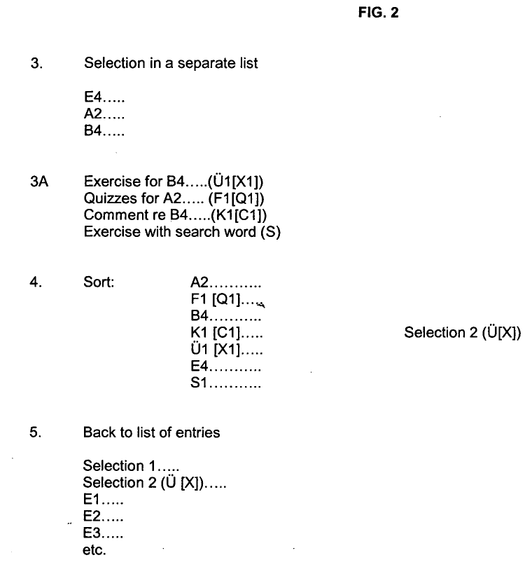

FIG. 2 schematically shows the inclusion of additional entries in the teaching module;

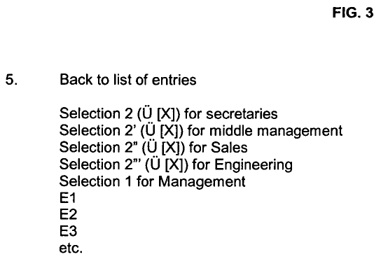

FIG. 3 schematically illustrates the creation of differentiated teaching modules intended for different user groups;

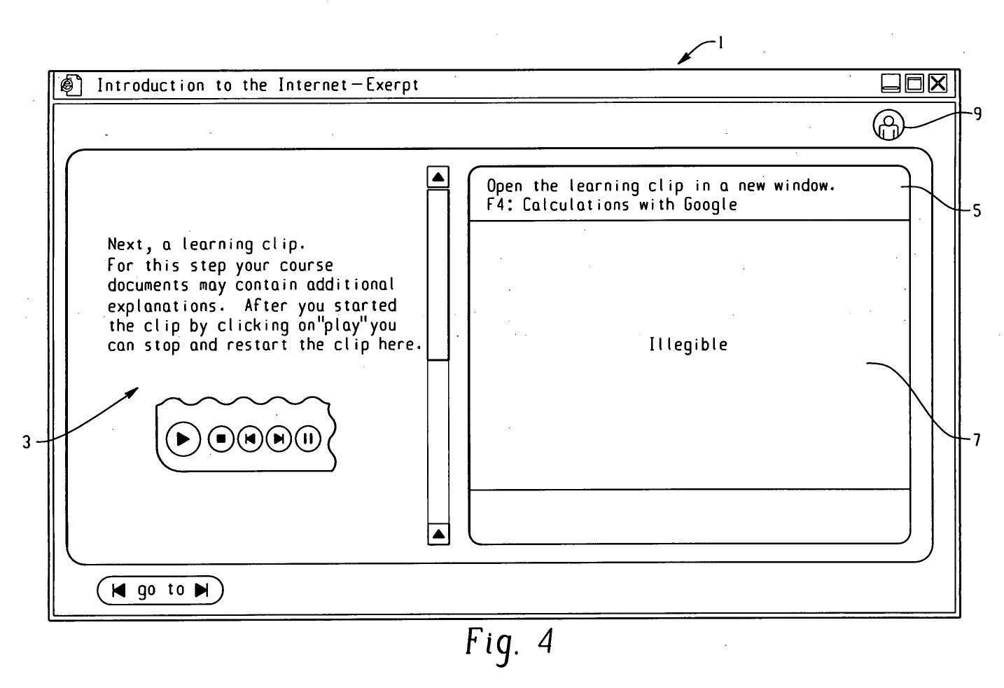

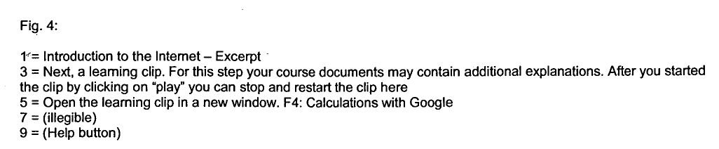

FIG. 4 shows a learning window as a step or part of a teaching module; and

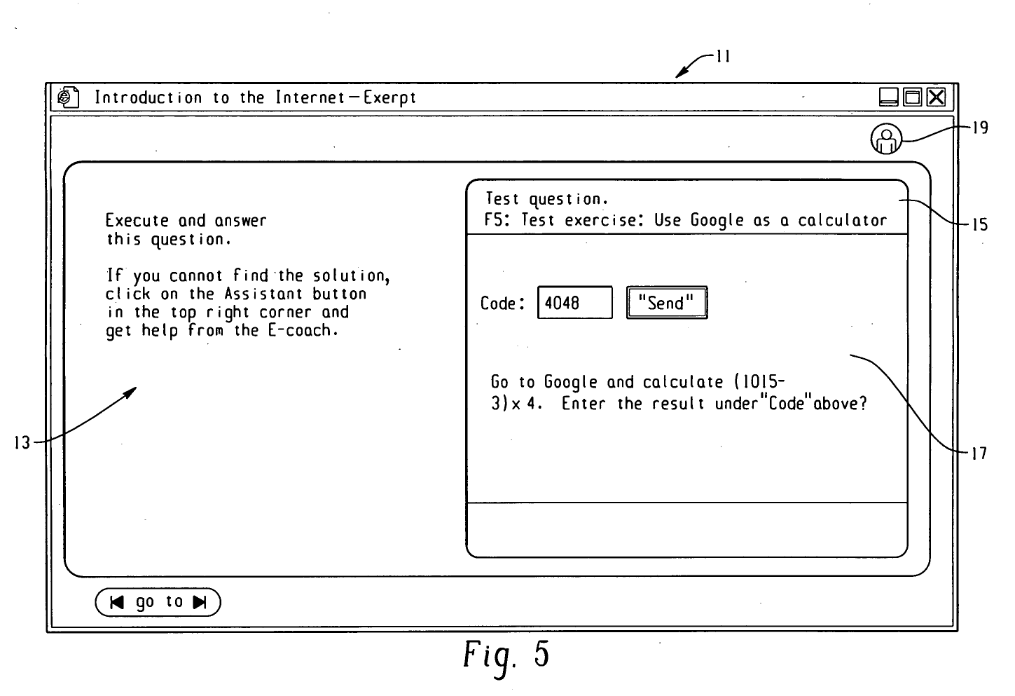

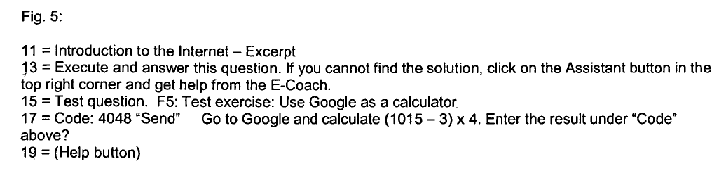

FIG. 5 shows another learning window, containing an exercise and interactive quiz as part of a teaching module.

FIG. 1 is a schematic flow diagram showing the basic principle of the method according to the invention. In step 1, a search word, represented by XYZ, is entered in a web-based search engine such as Altavista, Google, Yahoo etc. or a company-internal network search tool. Next, depending on the search engine or search tool, the entire Internet is searched for the key words concerned and, as schematically illustrated in step 2, a list is prepared containing the entries and links associated with that search word. The more general a search word XYZ is chosen, the larger the list of entries will be. As an example, entering “Switzerland” as the search word will yield about 40 million entries. By comparison, entering “koala bear” still brings up about 22,000 entries. Polydiallylphthalate finally produced a mere 27 entries in the list generated by the search engine. But even if there are only 100 or 200 entries, finding the links most relevant to his knowledge base and learning objective becomes extremely difficult for a user. In particular, it must be remembered that, to expand his knowledge in the desired manner, the user would typically have to rummage through a multitude of entries and from these extract those that are right in terms of his knowledge level.

With the above, a user or a specially designated person creating teaching modules is now in a position to prepare a selection from the results list generated by the search engine. To that end, a specially coded “click” on the selected entry or link will send that to a separate file for instance in the form similar to an on-line shopping basket, constituting a draft teaching module. What this means is that the entry concerned is not itself opened but that its link is recorded in the separate file.

These records can additionally include annotations pointing to particularly interesting pages or sections of the entries concerned and allow for the added inclusion of study-related information on this learning step in the teaching module. Step 3 in FIG. 1 illustrates an example of such a selection as a draft teaching module. Once all of the entries needed for the learning process have been filed in the draft version of the teaching module 3, the individual learning steps can be configured, supplemented and sorted along didactic considerations.

Concluding the process, the now final teaching module is entered in the search engine as a new entry. At that point, notes may be added identifying the learning objective of the teaching module, the author, appropriate search words as well as the user group for which it is intended, in many cases reflecting and building on the user's existing knowledge level.

So when a user enters the original search word XYZ, he will find that there already exist teaching modules that eliminate for him the chore of collecting and selecting and give him additional instructions. When he clicks on a teaching module, that module will cause a learning window to guide him interactively through the individual data and links of interest.

Depending on whether the vehicle is a generally available search engine such as Google or Altavista or a proprietary company-internal search tool, a teaching module can be accessed by anyone or only by a specific group of people such as the employees of a company.

Referring to FIG. 1, the basic principle of the method according to the invention is illustrated in a schematic diagram. It is possible, of course, to add enhancements to the method according to the invention. For example, again as illustrated in a flow diagram in FIG. 2, more entries can be added to the teaching module per step 3 in FIG. 1. This may for instance be an exercise under entry B4 as schematically illustrated by step 3A in FIG. 2, or a quiz under entry A2, or a particular comment regarding entry B4, or a general exercise relating to the search word originally entered into the search engine. As schematically illustrated in step 4 of FIG. 2, all of these additional entries, together with the selected entries, can subsequently be structured, i.e. configured and sorted. There would be no point in adding an exercise under entry B4 before that entry is opened, since at that juncture the user has not yet seen the information under entry B4.

Once the teaching module has been sorted and structured, it is filed in the search engine as an entry, as explained further above.

Assuming a user, for instance in a company such as a financial service provider, enters the search word “money laundering”, the screen will display not only innumerable entries but also already existing teaching modules, preferably at the top of the results list. The system will also display cross references to printed literature (with indication of the passage in the text). In addition, the system will further tell him who is an expert on the subject of the search word (expert reference). Based on the learning objective and the target group identified in the teaching modules he will know whether someone like an author has already done the compilation for him.

When he selects the teaching module, a learning window appearing on the monitor of his PC or screen of his laptop will interactively guide him in didactically correct fashion through the individual informational details of interest to him, such as Internet addresses/URLs, Internet or intranet links, files, literature and other sources of information. In addition he will receive instructions, exercises, comments, quizzes etc.

In a company, the teaching modules will necessarily be created by the person responsible for training. The system thus serves not only to provide information but also to train the employees.

Especially in large corporations it is often undesirable to create on a given subject one single teaching module for all employees. Instead, it makes good sense to generate differentiated teaching modules for different employee groups. FIG. 3, again in a schematic illustration, shows such a list of different teaching modules under a particular search word. For example, teaching module 2 covers exercises for secretaries, while teaching module 2′ contains exercises for middle management. It also includes teaching module 1 as a pure detailed information menu for management without quizzes and exercises. These teaching modules are often generated by copying and modifying existing teaching modules.

Finally, the various teaching modules are followed by the original entries as listed under item 2 in FIG. 1.

FIG. 4 shows a learning window 1 as part of a teaching module, i.e. one of a sequence of learning windows that guide the user through the teaching module. Based on the teaching module or the menu, a learning window guides the user interactively through detailed information and, where appropriate, gives him additional instructions. For example, any instructions 3 by the author of the teaching module may be displayed on the left side of the learning window 1. On the top right there may be a brief description 5 of the step concerned, and perhaps on the bottom right or in an additional pop-up window the detailed information 7, currently selected by the teaching module, is displayed. That information detail could for instance be a web page or a part excerpted from it, or a video clip, a PDF document, printed literature or even a person (expert), etc. To restate what has been said before: the detailed information could have been selected directly out of the hits of the search engine if one knew where to find it. Unfortunately, that is not often the case. Finally, perhaps in the top right corner, there may be a Help button 9 that puts the user in touch with the author of the teaching module for instance by e-mail and/or provides some other assistance.

As stated above in reference to FIG. 2, a teaching module may also contain quizzes, exercises and additional comments. As an example, FIG. 5 shows a learning window 11 that contains a quiz question.

Section 13 contains corresponding instructions, section 15 shows the title of the exercise and in field 17 appears the quiz question, i.e. the question to be interactively answered. Finally, the learning window 11 includes a Help button 19.

In addition, the learning window can be used for scheduling and for keeping track of who has worked himself through which teaching module. This permits success tracking, making the achieved knowledge transfer measurable, for instance by external monitoring of which employees have in fact opened and worked through a particular teaching module. In other words, the knowledge transfer system according to the invention can serve not only as a teaching aid for employees or in general for a particular group of people but also as a means for monitoring and controlling the entire learning process. This is true even if a teaching module consists of nothing more than bibliographic cross references. Computer-aided, the student independently works through printed literature, but his learning progress and quality is still measurable.

As another additional feature, a student who has a problem understanding something and needs help, can contact the author of the teaching module, when the search engine shows for instance the e-mail address of the author of the teaching module.

Modern companies view the existing knowledge base as an important resource. This system keeps track of who has catalogued informational details in the search engine, who has entered teaching modules and who is using teaching modules. This makes the knowledge transfer measurable and, in an extreme case, even accountable—a requirement on which several large banks are now insisting for an assessment of the quality and substance of an enterprise. The search engine keeps a record of users from which it can be seen, and measured, with what degree of intensity each employee is participating in the knowledge transfer.

The great advantage of the method according to the invention consists in the fact that, for example, the knowledge existing in a company can be made available, monitored and passed on in simple, time-efficient and learnable fashion to and by the employees or users. In a company, nearly all knowledge exists in explicit form somewhere in IT or in manuals, but it must first be catalogued in a central location. According to the invention, this is accomplished for instance by means of a company-internal search engine, thus establishing a base for the creation of teaching modules, supplemented by exercises, study programs, comments etc.

In summary, it bears mentioning again that, today, virtually all explicit knowledge of the world can be found on the Web and in printed literature. This is also true within a given business enterprise. But that knowledge cannot be acquired in the absence of teaching modules and of focused, detailed information selections geared in a didactically correct sequence to the knowledge level and learning objective of the target group concerned.

What gave rise to this invention was John Naisbitt's statement saying “we are drowning in information but thirsting for knowledge”. That need is satisfied by this present invention. With the method according to the invention, the Internet and, respectively, the search process, emancipates from a source of informational details into a source of knowledge.

1. Method for structurally supplementing search engines on the Internet, intranet and/or individual networks, characterized in that from a list of informational details relating to at least one particular search word at least one entry or so-called link or cross-reference is selected and placed in a separate file or some kind of basket, whereupon the selected entries and references are configured and sorted, if and as needed, and returned to the original list under the particular search word as a new entry or selection, tagged as a specific selection.

2. Method as in claim 1, characterized in that several entries or links or references are selected, that at least one new individual contribution is added to the separate list and that thereupon the list or selection, restructured and resorted if and as needed, is specially tagged and added to the corresponding list under the search word concerned.

3. Method as in claim 1, characterized in that to the list or menu of selections at least one contribution is added in the form of an entry such as a comment, a questionnaire, an exercise, a cross reference to a specific publication, etc., whereupon the list of selections, restructured and resorted if and as needed, is specially tagged and added to the corresponding list under the search word concerned.

4. Method for supplementing search engines as in claim 1 with at least one teaching module and perhaps a learning window, characterized in that the teaching module(s) is/are composed of the selection or additional entries in the results list of a search engine.

5. Method as in claim 1, characterized in that the separate file with the selected entries and references, including one or several individual contributions as applicable, is structured along a study program and/or in a specific sequence, whereupon the separate file including the study program, perhaps including a learning window, is specially tagged and added to the corresponding list under the search word concerned, and that, as appropriate and on the basis of the teaching module, said learning window can guide the user in focused fashion through the informational details or sections thereof.

6. Method as in claim 4, characterized in that, in a step within the teaching module, the reference to an informational detail additionally includes information giving supplementary assistance to the self-teaching person.

7. Method as in claim 4, characterized in that the teaching module is expanded by at least one additional learning step in the form of an instruction, a quiz question the correct answer to which can be verified by the learning window, an exercise, etc., making self-teaching an interactive process.

8. Individual selection menu entry or teaching module for a list created by a search engine under a specific search word, said entry generated by a method as specified in claim 1, characterized in that the selection or teaching module contains entries and links specially selected from the search engine list as well as cross references, where applicable, to existing literature and knowledge carriers, and, as applicable, additional individual contributory entries such as comments, exercises, questionnaires, summaries etc.

9. Entry as in claim 8, characterized in that the teaching module additionally contains a learning window designed to guide the user of the teaching module in targeted fashion through the detailed list of entries and links as well as individual contributions.

10. Use of the selection or of the teaching module according to claim 8, characterized in that it constitutes an enhancing expansion of a search engine or of a search process in a self-teaching system or knowledge transfer system, that the results list of the search engine is expanded by a teaching module on the basis of which a user can be guided by a learning window, in targeted fashion, through the individual entries and links as well as added entries.

11. Use as in claim 10, characterized in that the functionality of the self-teaching system or knowledge transfer system and/or of the teaching modules includes a progress monitoring capability by means of which it is possible to track the learning progress of the users via the search engine.

12. Use as in claim 10, characterized in that the teaching modules are tailored to a specific user group in adaptation to their knowledge base and knowledge objective, in particular as in the case of a company with a particular group of employees.

13. Use as in claim 10, characterized in that it permits external access to the study program so as to enable an administrator to monitor the learning progress.

14. Use as in claim 10, characterized in that a specific help function is provided for the student, making it possible to contact the author of a teaching module.

15. Use as in claim 10, characterized in that by means of the system it is possible to measure the knowledge transfer in a company and to also quantify it by individual knowledge carriers.

16. Use as in claim 10, characterized in that by means of the system the existing corporate substance can be measured and quantified for instance within the scope of a company evaluation.

17. Use as in claim 1, characterized in that by means of the system it is possible to evaluate individual employees both as knowledge carriers and as knowledge providers.
